(19) United States
(12) Patent Application Publication
(10) Pub. No.: US 2010/0223086 A1
(43) Pub. Date: Sep. 2, 2010

(54) Determining A Course Of Action While Managing Resources

(75) Inventors: Michael J. Hirsch, Orlando, FL (US); Brandon C. Ha, Garland, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/711,391

(22) Filed: Feb. 24, 2010

Related U.S. Application Data
(60) Provisional application No. 61/156,228, filed on Feb. 27, 2009.

(51) Int. Cl. G06Q 10/00; G06Q 50/00; G06N 5/02

(52) U.S. Cl. 705/8; 705/301; 705/348; 706/47

(57) ABSTRACT

According to one embodiment, determining a course of action includes receiving a problem description describing an optimization problem. The optimization problem comprises resources and adversarial objects. A resource performs an action, and an adversarial object performs a reaction in response to the action. The optimization problem is decomposed into sub-problems, where each sub-problem corresponds to an adversarial object. Each sub-problem is solved to yield an optimal sub-solution. It is determined whether there are one or more resource conflicts among the sub-solutions. A resource conflict occurs if a resource is required to perform more than one action at a stage. If there are one or more resource conflicts, a fixing procedure is applied to address the resource conflicts.

### RELATED APPLICATION

This application claims benefit under 35 U.S.C. §119(e) of U.S. Provisional Application Ser. No. 61/156,228, entitled “Course of Action Analysis System Using a Game Theoretic Approach,” Attorney's Docket 064750.0552 (PD 08E414), filed Feb. 27, 2009, by Michael Hirsch et al., which is incorporated herein by reference.

### TECHNICAL FIELD

This invention relates generally to the field of decision analysis and more specifically to determining a course of action while managing resources.

### BACKGROUND

An optimization software application may provide decision making capabilities. Such application may determine an optimal solution given particular criteria. The optimal solution may indicate a particular course of action to take.

### SUMMARY OF THE DISCLOSURE

In accordance with the present invention, disadvantages and problems associated with previous techniques for determining a course of action may be reduced or eliminated.

According to one embodiment, determining a course of action includes receiving a problem description describing an optimization problem. The optimization problem comprises resources and adversarial objects. A resource performs an action, and an adversarial object performs a reaction in response to the action. The optimization problem is decomposed into sub-problems, where each sub-problem corresponds to an adversarial object. Each sub-problem is solved to yield an optimal sub-solution. It is determined whether there are one or more resource conflicts among the sub-solutions. A resource conflict occurs if a resource is required to perform more than one action at a stage. If there are one or more resource conflicts, a fixing procedure is applied to address the resource conflicts.

Certain embodiments of the invention may provide one or more technical advantages. A technical advantage of one embodiment may be that decomposing an optimization problem into sub-problems and solving each sub-problem individually may be more efficient than solving the optimization problem itself. Another technical advantage of one embodiment may be that resource conflicts, where a resource is assigned to perform different actions at the same stage, may be identified. A fixing procedure may be applied to resolve the resource conflicts.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example of a system that determines a course of action while managing resources;

FIG. 2 illustrates an example of a decision tree that represents an optimization problem; and

FIG. 3 illustrates an example of a method that determines a course of action while managing resources.

### DETAILED DESCRIPTION OF THE DRAWINGS

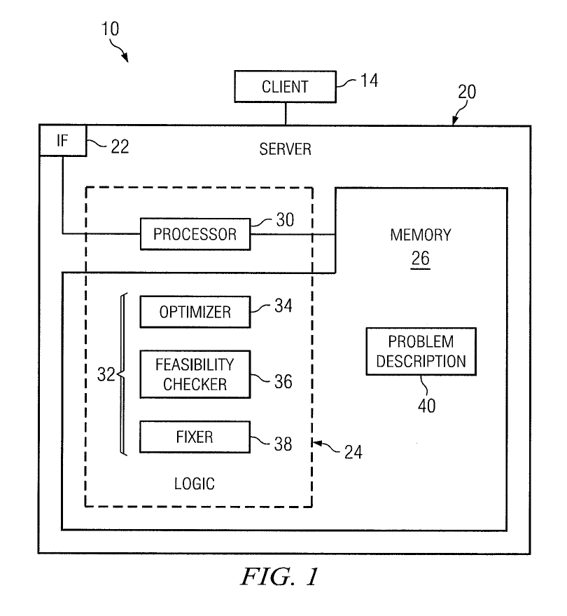

Embodiments of the present invention and its advantages are best understood by referring to FIGS. 1 through 3 of the drawings, like numerals being used for like and corresponding parts of the various drawings.

FIG. 1 illustrates an example of a system 10 that determines a course of action while managing resources. In certain embodiments, system 10 may decompose an optimization problem into sub-problems and solve each sub-problem individually. This may be more efficient than solving the optimization problem itself. In certain embodiments, system 10 may identify resource conflicts, where a resource is assigned to perform different actions at the same stage, and may apply a fixing procedure to resolve the resource conflicts.

In certain embodiments, system 10 includes a client 14 and a server 20. Server 20 includes an interface 22, logic 24, and a memory 26. Logic 24 includes a processor 30, and a course of action (COA) analyzer 32. COA analyzer 32 includes an optimizer 34, a feasibility checker 36, and a fixer 38. Memory 26 stores a problem description 40 and COA analyzer 32.

Client 14 allows a user to send input to server 20 and receive an output from server 20. In certain embodiments, client 14 may include a computing system that communicates with server 20 that comprises a separate computing system. In other embodiments, client may include input and/or output devices that communicate with server 20 that comprises a computing system.

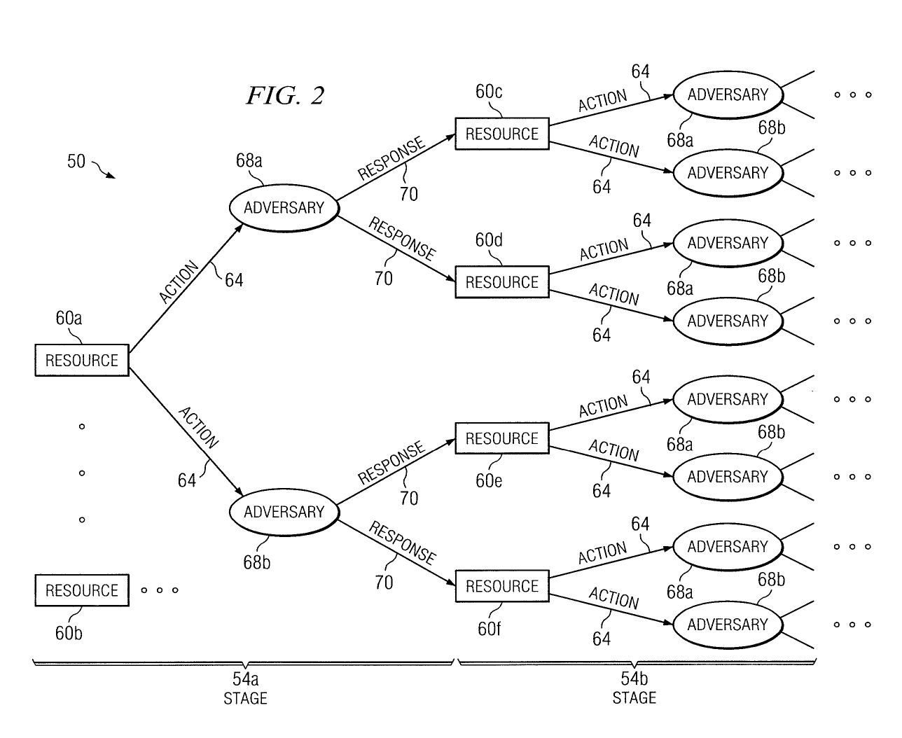

Server 20 operates to provide a solution to an optimization problem. In certain embodiments, an optimization problem may be described by problem description 40. An example of an optimization problem is described with reference to FIG. 2.

FIG. 2 illustrates an example of a decision tree 50 that represents an optimization problem. Decision tree 50 may be expressed in any suitable manner. For example, decision tree 50 may be expressed in a graphical format, as illustrated. As another example, decision tree 50 may be expressed as a graph with nodes (for example, resources 60 and adversarial objects 68) and directed edges (for example, actions 64 and reactions 70). In certain cases, the nodes and/or edges may be represented by ordered sets and/or pointers.

Decision tree 50 may represent any suitable optimization problem. For example, decision tree 50 may represent an optimization problem that determines an optimal course of action for military maneuvers. In the illustrated example, decision tree 50 includes stages 54 (54a-b), resources 60 (60a-b), actions 64, adversarial objects (or adversaries) 68 (68a-b), and reactions 70.

A stage 54 includes an iteration of resources 60 performing actions 64 in response to which adversarial objects 68 perform reactions 70. Decision tree 50 may have any suitable number of stages 54, such as 2, 3, 4, or more stages 54.

A resource 60 may perform an action 64. In the military example, resources 60 may be used by friendly forces against enemy forces. Examples of resources 60 may include aircraft, sea-going vessels, land-based vehicles, and/or personnel. In certain embodiments, decision tree 50 may include an imaginary resource 60 that is assigned to perform an action 64 only if no real resource 60 is available. Decision tree 50 may include any suitable number of resources 60, such as 2 to 3, 3 to 5, 5 to 8, or more than 8 resources 60. A resource 60 may perform any suitable maximum number of actions (no more than one at each stage 54), such as 3 to 5 or more than 5 actions.

A resource 60 may have a cost of using the resource 60. The cost may be expressed in any suitable manner, for example, in monetary units, man-hours, personnel, or any other suitable unit. In the military example, a resource 60 may be expressed in terms of dollars. In certain embodiments, the cost of an imaginary resource 60 may be a maximum cost that limits the assignment of the imaginary resource 60 to adversarial objects, except when there is no real resource 60 available.

An action 64 may be a task that is performed. In the military example, an action 64 may be performed by friendly forces against enemy forces. An action 64 is associated with a cost of performing the action 64. Any suitable number of actions 64 may be performed at a stage 54, such as less than 3, 3 to 5, or more than 5 actions 64.

An adversarial object 68 may be any suitable actor that responds to an action 64 performed by resource 60. In the military example, adversarial object 68 may represent an enemy force. Decision tree 50 may have any suitable number of adversarial objects 68, such as 2 to 3, 3 to 5, 5 to 8, or more than 8 objects 68.

A reaction 70 is an action performed by an adversarial object 68 in response to an action 64. In the military example, reaction 70 may be a military retaliation. A reaction 70 is associated with a probability that the reaction will occur. Any suitable number of reactions 70 may be performed at a step 54, such as less than 3, 3 to 5, or more than 5 reactions 70.

In the illustrated example, an action arrow and a reaction arrow indicate a causal direction. A resource 60 performs an action 64, in response to which adversary 68 performs a reaction 70.

In certain embodiments, decision tree 50 includes paths. A path may be a series of one or more resources 60, one or more actions 64, one or more adversarial objects 68, and/or one or more reactions 70 that are coupled together in the direction indicated by the action and reaction arrows. An optimal path may provide a recommended course of action that recommends the resources 60 and actions 64 of the path taken in the order indicated by the action and reaction arrows.

A path may be associated with, or correspond to, an adversarial object 68 if the path includes the adversarial object. In certain embodiments, the path corresponding to an adversarial object 68 includes only that adversarial object 68 and no other adversarial objects 68. A path may be associated with an adversarial object 68 may be used to define a sub-problem for adversarial object 68.

Returning back to FIG. 1, COA analyzer 32 performs Course of Action (COA) analysis and resource management to allocate resources over time to effect actions. COA analyzer 32 provides recommended courses of action given resources and constraints.

Optimizer 34 solves an optimization problem to determine an optimal solution. An “optimal” solution is the best solution of an optimization problem given particular inputs, but not necessarily the best possible solution. For example, providing more accurate inputs to an optimization problem may provide a better solution than providing less accurate inputs. Optimizer 34 may include mathematical models (for example, linear models and/or quadratic models). An example of an optimization software application is the CPLEX optimization software package of ILOG Incorporated, located in Sunnyvale, Calif.

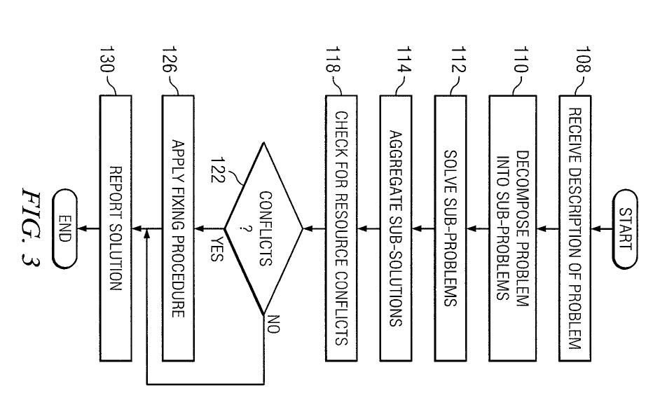

In certain embodiments, COA analyzer 32 includes an optimizer 34, a feasibility checker 36, and a fixer 38. Optimizer 34 receives a problem description 40 which describes an optimization problem. Optimizer 34 decomposes the problem into sub-problems that each correspond to an adversarial object. Optimizer 34 then solves the sub-problems to yield optimal sub-solutions. Optimizer 34 then aggregates the sub-solutions and sends the aggregated solution to feasibility checker 36. Feasibility checker 36 checks for resource conflicts. If there are conflicts, fixer 38 applies a fixing procedure. The method used by COA analysis is described in more detail with reference to FIG. 3.

In certain embodiments, optimizer 34 optimizes a sub-problem by representing the sub-problem as a decision tree comprising paths. A cost for each path may be calculated to yield a plurality of path costs. The cost may be calculated by calculating a cost for a resource to perform an action at each stage of the path. The path with a minimum path cost may be identified. The identified path indicates the sub-solution for each sub-problem.

In certain embodiments, optimizer 34 may solve an optimization problem according to the following example of an optimization format. The example optimization format may use the following indices:

resources: IεI={1, . . . I}

stages: kεK={1, . . . K}

actions a resource can perform at stage k: jₖεJ={1, . . . J}

objects: lεL={1, . . . L}

reactions at stage k: rₖεR={1, . . . R}

The example optimization format may use the following decision variables:

xᵢⱼ_{ₖ}ⱼ_{_{k−1}}ᵣ_{_{k−1}}ₗ=
1, if action jₖ is performed by resource i on object l at stage k and object l had reaction rₖ₋₁ to action jₖ₋₁ performed on object l during stage k−1; and
0, otherwise.

zⱼ_{ₖ}ⱼ_{_{k−1}}ᵣ_{_{k−1}}ₗ=
1, if action jₖ is performed on object l at stage k, action jₖ₋₁ performed on object l during stage k−1, and object l had reaction rₖ₋₁ to action jₖ₋₁; and
0, otherwise.

The example optimization format may use the following parameters:

Cost fᵢⱼₖₗ: cost incurred by resource i to perform action jₖ on adversarial object l at stage k.

Expected benefit eⱼ_{ₖ}ₗ: expected benefit of performing action jₖ on adversarial object l at stage k.

Cost cⱼ_{ₖ}ⱼ_{_{k−1}}ᵣ_{_{k−1}}ₗ: cost of performing action jₖ on adversarial object l at stage k when action jₖ₋₁ was performed on this adversarial object at stage k−1 with reaction rₖ₋₁.

Cost ρⱼ_{ₖ}ᵣ_{ₖ}ₗ: cost of the chosen action performed at stage k+1 on adversarial object l given action jₖ was performed on this object at stage k with reaction rₖ.

The example optimization format may use the following constraints. Unless otherwise noted, constraints are defined for each jₖ εJ, rₖ εR, IεI, lεL, and kεK, as appropriate:

Expected benefit constraint represents the expected benefit for performing action jₖ on adversarial object l at stage k:

$${e}_{{j}_{k} 𝓁} = {\sum }_{{r}_{k} ∈ R} {a}_{{j}_{k} {r}_{k}} {ρ}_{{j}_{k} {r}_{k} 𝓁}$$

Cumulative expected cost constraint represents the cumulative expected cost of performing action jₖ on adversarial object l at stage k when action jₖ₋₁ was performed on this object at stage k−1, with reaction rₖ₋₁:

$${c}_{{j}_{k} {j}_{k - 1} {r}_{k - 1} 𝓁} = {e}_{{j}_{k} 𝓁} + {\sum }_{i ∈ I} {f}_{{ij}_{k} {lxij}_{k} {j}_{k - 1} {r}_{k - 1} 𝓁}$$

Selection constraint represents the selection of action jₖ₊₁ at stage k+1 on adversarial object l:

$${ρ}_{{j}_{k} {r}_{k} 𝓁} = {\sum }_{{j}_{k + 1} ∈ J} {c}_{{j}_{k + 1} {j}_{k} {r}_{k} 𝓁} {z}_{{j}_{k + 1} {j}_{k} {r}_{k} 𝓁}$$

Resource assignment constraint yields zⱼ_{_{k,}}ⱼ_{_{k−1,}}ᵣ_{_{k−1,}}ₗ=1 if a resource is assigned to perform action jₖ on adversarial object l at stage k:

$${\sum }_{i ∈ I} {x}_{{ij}_{k} {j}_{k - 1} {r}_{k - 1} 𝓁} \leq {z}_{{j}_{k} {j}_{k - 1} {r}_{k - 1 ,} 𝓁}$$

Single action constraint constrains exactly one action to be chosen for adversarial object l at stage k:

$${\sum }_{{{r}_{k - 1} ∈ R}_{{j}_{k} , {j}_{k - 1} ∈ J}} {z}_{{j}_{k} {j}_{k - 1} {r}_{k - 1} 𝓁} = 1$$

Single resource constraint forces exactly one resource (such as a real or an imaginary resource) to be assigned to adversarial object l at stage k:

$${\sum }_{{{r}_{k - 1} ∈ R , i ∈ I}_{{j}_{k} , {j}_{k - 1} ∈ J}} {x}_{i , {j}_{k} {j}_{k - 1} {r}_{k - 1} 𝓁} = 1$$

Resource constraint limits each resource to perform no more than one action in any given stage:

$${\sum }_{{{r}_{k - 1} ∈ R , 𝓁 ∈ L}_{{j}_{k} , {j}_{k - 1} ∈ J}} {x}_{{ij}_{k} {j}_{k - 1} {r}_{k - 1} 𝓁} \leq 1$$

Decision relation constraint relates the decisions made at consecutive stages:

$${\sum }_{{{r}_{k - 2} ∈ R , i ∈ I}_{{j}_{k - 2} ∈ J}} {x}_{{ij}_{k - 1} {j}_{k - 2} {r}_{k - 2} 𝓁} \geq {{\sum }_{{r}_{k - 1} ∈ R , i ∈ I}}_{{j}_{k} ∈ J} {x}_{{ij}_{k} {j}_{k - 1} {r}_{k - 1} 𝓁}$$

Default settings constraint prescribes initial default settings for the last decision stage:

eⱼ_{ₖ}ₗ=0

The example optimization format may use the following objective function:

$$min F = {\sum }_{𝓁 ∈ L} {ρ}_{00 𝓁}$$

The objective function minimizes the sum of the cost of the chosen actions performed at the first stage decision process, over the objects. At the first stage (k=1), previous actions and potential reactions are not defined, so indices j₁ and r₁ are set to 0. The expected benefit, cumulative expected cost, and selection constraints form a chain in the decision tree, linking costs associated with consecutive stages. Hence, the objective function may be regarded as minimizing the cumulative expected cost from the individual action costs associated at each decision stage in the decision making process over the objects.

Problem description 40 describes an optimization problem. In certain embodiments, problem description 40 may describe an optimization problem represented by decision tree 50. In the embodiments, problem description 40 may include decision tree 50.

FIG. 3 illustrates an example of a method that determines a course of action while managing resources. Examples of inputs include resource information (such as availability and/or capability of resources), actions, cost of performed actions, adversary reactions, probability of adversary reactions, and/or number of decision stages. Examples of outputs include actions that each resource will perform at each stage of one, two or more, or all stages and/or an assignment of resources to actions at each stage of one, two or more, or all stages.

The method starts at step 108, where problem description 40 of an optimization problem is received. Problem description 40 describes an optimization problem. In certain embodiments, the optimization problem comprises resources 60 and adversarial objects 68.

The problem is decomposed into sub-problems at step 110. In certain embodiments, each sub-problem corresponds to an adversarial object. The sub-problems are solved at step 112 to yield sub-solutions. Sub-problems may be solved by optimization techniques. In certain embodiments, a minimum cost path that allocates resources to objects at each stage may be calculated.

In certain embodiments, a sub-problem may be represented as a decision tree comprising paths. A cost for each path may be calculated to yield a plurality of path costs. The cost may be calculated by calculating a cost for a resource to perform an action for each stage of the path. The path with a minimum path cost may be identified. The identified path indicates the sub-solution for the each sub-problem.

The sub-solutions are aggregated at step 114. Sub-solutions may be aggregated by collecting the sub-solutions into a set.

Resource conflicts are checked for at step 118. In certain embodiments, a resource conflict occurs if a resource is required to perform more than one action 64 at a stage 54. A resource conflict may be identified by checking whether the sub-solutions assign a resource to perform different actions at the same stage.

There may be one or more resource conflicts at step 122. If there are no resource conflicts, the method proceeds to step 130. If there are one or more resource conflicts, the method proceeds to step 126, where a fixing procedure is applied. A fixing procedure is a procedure that reduces or removes resource conflicts.

In certain embodiments, applying a fixing procedure may include determining actions that a resource has been assigned to perform and identifying an action that can be assigned an unallocated resource. The action may be identified by calculating a marginal cost for each action and identifying an action with a minimal marginal cost. A marginal cost for an action may represent an increase in cost resulting from assigning an unallocated resource to the action.

The solution is reported at step 130. The solution may be reported in any suitable manner. For example, the solution may be sent to client 14, which presents the solution in any suitable manner. For example, the solution can be presented using a visual display, an audio speaker, and/or a print out.

A component of the systems and apparatuses described herein may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. For example, the operations of feasibility checker 36 and fixer 38 may be performed by one component, or the operations of fixer 38 may be performed by more than one component. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The method may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method comprising:
receiving a problem description describing an optimization problem, the optimization problem comprising a plurality of resources and a plurality of adversarial objects, a resource operable to perform an action, an adversarial object operable to perform a reaction in response to the action;
decomposing the optimization problem into a plurality of sub-problems, each sub-problem corresponding to an adversarial object;
solving each sub-problem to yield a plurality of optimal sub-solutions;
determining if there are one or more resource conflicts among the sub-solutions, a resource conflict occurring if a resource is required to perform more than one action at a stage; and
if there are one or more resource conflicts, applying a fixing procedure to address the one or more resource conflicts.

2. The method of claim 1, the solving each sub-problem further comprising performing the following for each sub-problem:
receiving the each sub-problem as a decision tree comprising a plurality of paths;
determining a cost for each path to yield a plurality of path costs; and
identifying a path with a minimum path cost, the identified path indicating the sub-solution for the each sub-problem.

3. The method of claim 1, the solving each sub-problem further comprising performing the following for each sub-problem:
representing the each sub-problem as a decision tree comprising a plurality of paths; and
determining a cost for a path by calculating a cost for a resource to perform an action at each stage of the path.

4. The method of claim 1, the determining if there are one or more resource conflicts further comprising:
determining that the sub-solutions assign a resource to perform a plurality of actions at a same stage.

5. The method of claim 1, the applying a fixing procedure further comprising:
determining a plurality of actions that a resource has been assigned to perform; and
identifying an action that can be assigned an unallocated resource.

6. The method of claim 1, the applying a fixing procedure further comprising:
determining a plurality of actions that a resource has been assigned to perform;
calculating a marginal cost for each action, a marginal cost for an action representing an increase in cost resulting from assigning an unallocated resource to the action; and
identifying an action with a minimal marginal cost.

7. The method of claim 1:
the one or more resources representing one or more friendly forces; and
the one or more adversarial objects representing one or more enemy forces.

8. An apparatus comprising:
an interface operable to:
receive a problem description describing an optimization problem, the optimization problem comprising a plurality of resources and a plurality of adversarial objects, a resource operable to perform an action, an adversarial object operable to perform a reaction in response to the action; and
a processor operable to execute logic to:
decompose the optimization problem into a plurality of sub-problems, each sub-problem corresponding to an adversarial object;
solve each sub-problem to yield a plurality of optimal sub-solutions;
determine if there are one or more resource conflicts among the sub-solutions, a resource conflict occurring if a resource is required to perform more than one action at a stage; and
if there are one or more resource conflicts, apply a fixing procedure to address the one or more resource conflicts.

9. The apparatus of claim 8, the solving each sub-problem further comprising performing the following for each sub-problem:
receiving the each sub-problem as a decision tree comprising a plurality of paths;
determining a cost for each path to yield a plurality of path costs; and
identifying a path with a minimum path cost, the identified path indicating the sub-solution for the each sub-problem.

10. The apparatus of claim 8, the solving each sub-problem further comprising performing the following for each sub-problem:
representing the each sub-problem as a decision tree comprising a plurality of paths; and
determining a cost for a path by calculating a cost for a resource to perform an action at each stage of the path.

11. The apparatus of claim 8, the determining if there are one or more resource conflicts further comprising:
determining that the sub-solutions assign a resource to perform a plurality of actions at a same stage.

12. The apparatus of claim 8, the applying a fixing procedure further comprising:
determining a plurality of actions that a resource has been assigned to perform; and
identifying an action that can be assigned an unallocated resource.

13. The apparatus of claim 8, the applying a fixing procedure further comprising:
determining a plurality of actions that a resource has been assigned to perform;
calculating a marginal cost for each action, a marginal cost for an action representing an increase in cost resulting from assigning an unallocated resource to the action; and
identifying an action with a minimal marginal cost.

14. The apparatus of claim 8:
the one or more resources representing one or more friendly forces; and
the one or more adversarial objects representing one or more enemy forces.

15. A tangible computer-readable medium having computer-executable code, when executed by a computer operable to:
receive a problem description describing an optimization problem, the optimization problem comprising a plurality of resources and a plurality of adversarial objects, a resource operable to perform an action, an adversarial object operable to perform a reaction in response to the action; and
decompose the optimization problem into a plurality of sub-problems, each sub-problem corresponding to an adversarial object;
solve each sub-problem to yield a plurality of optimal sub-solutions;
determine if there are one or more resource conflicts among the sub-solutions, a resource conflict occurring if a resource is required to perform more than one action at a stage; and
if there are one or more resource conflicts, apply a fixing procedure to address the one or more resource conflicts.

16. The medium of claim 15, the solving each sub-problem further comprising performing the following for each sub-problem:
receiving the each sub-problem as a decision tree comprising a plurality of paths;
determining a cost for each path to yield a plurality of path costs; and
identifying a path with a minimum path cost, the identified path indicating the sub-solution for the each sub-problem.

17. The medium of claim 15, the solving each sub-problem further comprising performing the following for each sub-problem:
representing the each sub-problem as a decision tree comprising a plurality of paths; and
determining a cost for a path by calculating a cost for a resource to perform an action at each stage of the path.

18. The medium of claim 15, the determining if there are one or more resource conflicts further comprising:
determining that the sub-solutions assign a resource to perform a plurality of actions at a same stage.

19. The medium of claim 15, the applying a fixing procedure further comprising:
determining a plurality of actions that a resource has been assigned to perform; and
identifying an action that can be assigned an unallocated resource.

20. The medium of claim 15, the applying a fixing procedure further comprising:
determining a plurality of actions that a resource has been assigned to perform;
calculating a marginal cost for each action, a marginal cost for an action representing an increase in cost resulting from assigning an unallocated resource to the action; and
identifying an action with a minimal marginal cost.

21. The medium of claim 15:
the one or more resources representing one or more friendly forces; and
the one or more adversarial objects representing one or more enemy forces.
